(19) United States
(12) Patent Application Publication
(10) Pub. No.: US 2015/0268675 A1
(43) Pub. Date: Sep. 24, 2015

(54) TEMPERATURE DIFFERENCE COMPENSATION SYSTEM AND METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JIAN-WEN GAO, Shenzhen (CN); XING-YU LIU, Shenzhen (CN); WEI ZHOU, Shenzhen (CN); PING LI, Shenzhen (CN)

(21) Appl. No.: 14/602,747

(22) Filed: Jan. 22, 2015

(30) Foreign Application Priority Data
Mar. 19, 2014 (CN) 201410102023.3

(51) Int. Cl. G05D 23/19; G05B 19/05; G01J 5/02

(52) U.S. Cl. CPC G05D 23/1917; G01J 5/025; G05B 19/05; G05B 2219/15121

(57) ABSTRACT

A temperature difference compensation system includes a rotary table configured to support a fixture, a hot air jet, an infrared thermometer, and a programmable logic controller electrically coupled to the hot air jet and the infrared thermometer. The hot air jet, the infrared thermometer, and the programmable logic controller are spaced from each other and positioned above the rotary table. The infrared thermometer is configured to measure a temperature of the fixture and transfer a value corresponding to the measured temperature to the programmable logic controller. The programmable logic controller is configured to control the hot air jet to heat the fixture according to the temperature measured by the infrared thermometer.

### FIELD

The subject matter herein generally relates to heat treatment systems, and particularly to a temperature difference compensation system and a temperature difference compensation method.

### BACKGROUND

A temperature of a fixture in a machine affects a quality of a workpiece positioned in the fixture. Such as, in a plasma curing process, a temperature of a fixture affects a curing effect.

### BRIEF DESCRIPTION OF THE DRAWINGS

Implementations of the present technology will now be described, by way of example only, with reference to the attached figures.

FIG. 1 is a diagrammatic view of an embodiment of a temperature difference compensation system.

FIG. 2 is a flowchart of an embodiment of a temperature difference compensation method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is in relation to a temperature difference compensation system which can include a rotary table configured to support a fixture, a hot air jet, an infrared thermometer, and a programmable logic controller electrically coupled to the hot air jet and the infrared thermometer. The hot air jet, the infrared thermometer, and the programmable logic controller can be spaced from each other and positioned above the rotary table. The infrared thermometer can be configured to measure a temperature of the fixture and transfer a value corresponding to the measured temperature to the programmable logic controller. The programmable logic controller can be configured to control the hot air jet to heat the fixture according to the temperature measured by the infrared thermometer.

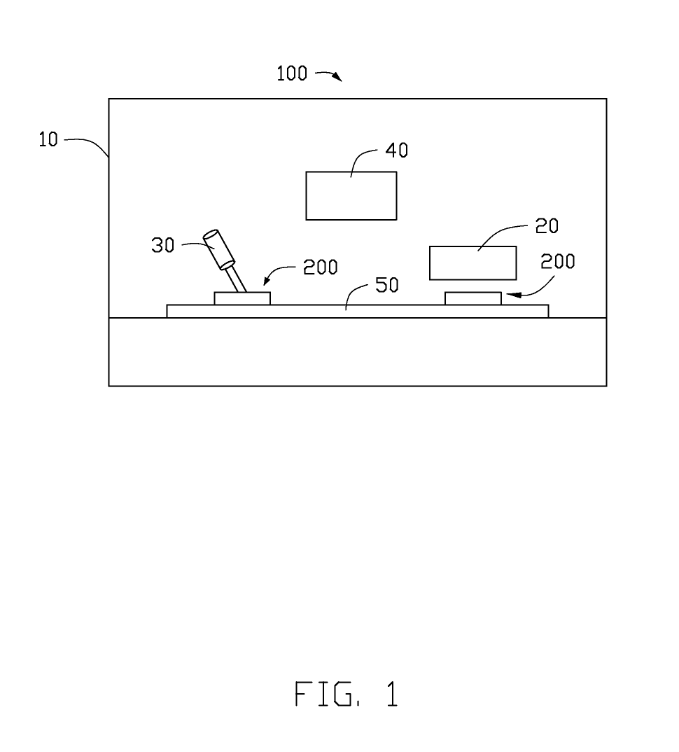

FIG. 1 illustrates an embodiment of a temperature difference compensation system 100 configured to compensate a temperature of a fixture 200 before a plasma curing process. The temperature difference compensation system 100 can include a plasma curing machine 10, a hot air jet 20, an infrared thermometer 30, a programmable logic controller 40, and a rotary table 50. The hot air jet 20, the infrared thermometer 30, the programmable logic controller 40, and the rotary table 50 can be received in the plasma curing machine 10.

The hot air jet 20, the infrared thermometer 30, and the programmable logic controller 40 can be fixed in the plasma curing machine 10 by fixing structures (not shown in FIG. 1). The hot air jet 20, the infrared thermometer 30, and the programmable logic controller 40 can be spaced from each other and positioned above the rotary table 50. Thus, a temperature of the fixture 200 can be measured and compensated. The hot air jet 20 and the infrared thermometer 30 can be electrically coupled to the programmable logic controller 40.

In the illustrated embodiment, there can be two fixtures 200 positioned on the rotary table 50. The hot air jet 20 can be configured to heat the fixtures 200 positioned under the hot air jet 20. The infrared thermometer 30 can measure a temperature of the fixture 200 positioned under the infrared thermometer 30, and transfer the value corresponding to the measured temperature to the programmable logic controller 40. The programmable logic controller 40 can include a preset temperature prestored therein and configured to compare the preset temperature with the measured temperature. The programmable logic controller 40 can include a plurality of heating parameters prestored therein. Each heating parameter can include a heating time for heating the fixture 200 from a temperature to the preset temperature. Thus, the plurality of heating parameters can correspond to heating times of heating the fixture 200 from different temperatures to the preset temperature.

The programmable logic controller 40 can compare the measured temperature of the fixture 200 and the preset temperature, and select the corresponding heating parameter according to the measured temperature of the fixture 200. The rotary table 50 can be configured to rotate the fixture 200 on the rotary table 50. Thus, the fixture 200 adjacent to the infrared thermometer 30 can move to be positioned adjacent to the hot air jet 20. The programmable logic controller 40 can control the hot air jet 30 to heat the fixture 200 adjacent to the hot air jet 30 according to the corresponding heating parameter. Thus, the fixture 200 adjacent to the hot air jet 30 can reach a temperature equals to the preset temperature. The rotary table 50 can be further rotated to move the fixture 200 and a workpiece positioned in the fixture 200 can be cured by the plasma curing machine 10. In at least one embodiment, the heating parameter can include a temperature of air jetted by the hot air jet 20.

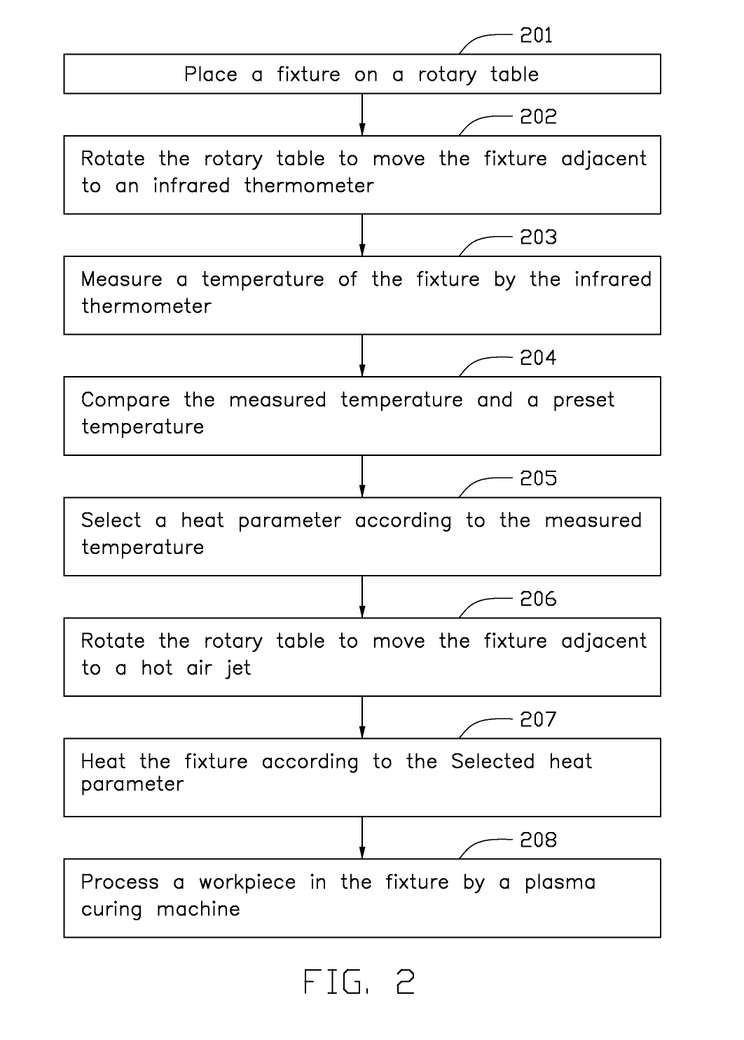

Referring to FIG. 2, a flowchart is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods or subroutines, carried out in the exemplary method. Furthermore, the illustrated order of blocks is by example only and the order of the blocks can change according to the present disclosure. Additional blocks may be added or fewer blocks may be utilized, without departing from the disclosure. The exemplary method can begin at block 201.

At block 201, a fixture can be placed on a rotary table.

At block 202, the rotary table can be rotated to move the fixture adjacent to an infrared thermometer.

At block 203, the infrared thermometer can measure a temperature of the fixture and transfer the value corresponding to the measured temperature to the programmable logic controller.

At block 204, the programmable logic controller can compare the measured temperature of the fixture and a preset temperature.

At block 205, the programmable logic controller can select a heat parameter according to the measured temperature of the fixture.

At block 206, the rotary table can be rotated to move the fixture adjacent to a hot air j et.

At block 207, the programmable logic controller can control the hot air jet to heat the fixture according to the selected heat parameter. Thus, the fixture can reach a temperature equals to the preset temperature.

At block 208, a plasma curing machine can process a workpiece positioned in the fixture.

In at least one embodiment, the temperature difference compensation system 100 can compensate a temperature of other members, such as a workpiece. The hot air jet 20, the infrared thermometer 30, the programmable logic controller 40, and the rotary table 50 can be not limited to be received in the plasma curing machine 10.

The embodiments shown and described above are only examples. Many details are often found in the art such as the other features of a temperature difference compensation system. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A temperature difference compensation system comprising:
a rotary table configured to support a fixture;
a hot air jet;
an infrared thermometer; and
a programmable logic controller electrically coupled to the hot air jet and the infrared thermometer,
wherein the hot air jet, the infrared thermometer, and the programmable logic controller are spaced from each other and positioned above the rotary table, the infrared thermometer is configured to measure a temperature of the fixture and transfer a value corresponding to the measured temperature to the programmable logic controller, the programmable logic controller is configured to control the hot air jet to heat the fixture according to the temperature measured by the infrared thermometer.

2. The temperature difference compensation system of claim 1, wherein the programmable logic controller includes a preset temperature prestored therein, the programmable logic controller is configured to compare the preset temperature and the temperature measured by the infrared thermometer.

3. The temperature difference compensation system of claim 2, wherein the programmable logic controller includes a plurality of heating parameters prestored therein, the programmable logic controller is configured to compare the preset temperature and the temperature measured by the infrared thermometer, and select the corresponding heating parameter according to the temperature measured by the infrared thermometer, the programmable logic controller controls the hot air jet to heat the fixture according to the corresponding heating parameter.

4. The temperature difference compensation system of claim 3, wherein each heating parameter includes a heating time for heating the fixture from a temperature to the preset temperature.

5. The temperature difference compensation system of claim 3, wherein each heating parameter includes a temperature of air jetted by the hot air jet.

6. The temperature difference compensation system of claim 1, further comprising a plasma curing machine that receives the hot air jet, the infrared thermometer, the programmable logic controller, and the rotary table.

7. A temperature difference compensation system comprising:
a plasma curing machine;
a rotary table configured to support a fixture;
a hot air jet;
an infrared thermometer; and
a programmable logic controller electrically coupled to the hot air jet and the infrared thermometer,
wherein the hot air jet, the infrared thermometer, the programmable logic controller, and the rotary table are provided in the plasma curing machine, the hot air jet, the infrared thermometer, and the programmable logic controller are spaced from each other and positioned above the rotary table, the infrared thermometer is configured to measure a temperature of the fixture, the programmable logic controller is configured to control the hot air jet to heat the fixture according to the temperature measured by the infrared thermometer.

8. The temperature difference compensation system of claim 7, wherein the programmable logic controller includes a preset temperature and a plurality of heating parameters prestored therein, the programmable logic controller is configured to select the corresponding heating parameter according to the temperature measured by the infrared thermometer, the programmable logic controller controls the hot air jet to heat the fixture according to the corresponding heating parameter.

9. The temperature difference compensation system of claim 8, wherein each heating parameter includes a heating time for heating the fixture from a temperature to the preset temperature.

10. The temperature difference compensation system of claim 8, wherein each heating parameter includes a temperature of air jetted by the hot air jet.

11. A temperature difference compensation method comprising:
placing a fixture on a rotary table;
rotating the rotary table to move the fixture adjacent to an infrared thermometer;
measuring a temperature of the fixture using the infrared thermometer and transferring a value corresponding to the measured temperature to a programmable logic controller;
comparing the measured temperature of the fixture and a preset temperature;
selecting a heat parameter according to the measured temperature of the fixture;
rotating the rotary table to move the fixture adjacent to a hot air jet; and
heating the fixture according to the selected heat parameter.

12. The temperature difference compensation method of claim 11, wherein after the fixture is heated, processing a workpiece positioned in the fixture by a plasma curing machine.

13. The temperature difference compensation method of claim 11, wherein the heating parameter includes a heating time for heating the fixture from a temperature to the preset temperature.

14. The temperature difference compensation method of claim 11, wherein the heating parameter includes a temperature of air jetted by the hot air jet.
